(19) United States
(12) Patent Application Publication
(10) Pub. No.: US 2026/0094485 A1
(43) Pub. Date: Apr. 2, 2026

(54) NOTE SORTING BY NOTE VERSION

(71) Applicant: NCR Atleos Corporation, Atlanta, GA (US)

(72) Inventor: Alexander Pearson Miller, Dundee (GB)

(21) Appl. No.: 18/902,393

(22) Filed: Sep. 30, 2024

(51) Int. Cl. G07D 11/50; G07D 11/22

(52) U.S. Cl. CPC G07D 11/50; G07D 11/22

(57) ABSTRACT

A system and technique may be used to classify a note according to a version of the note. An example technique may include receiving, at a note handling device, a note, capturing identifying information about the note, and determining, using the identifying information, an identifier corresponding to the note, the identifier including a type, a value, an issuer, and a version of the note. The example technique may include classifying the note according to a rule associated with the identifier, the rule indicating a classification for the note and automatically sorting the note, at the note handling device, into a particular bin of the note handling device based on the classification.

### BACKGROUND

Note handling devices are machines designed to process, sort, and manage various types of notes. Note handling devices such as automated teller machines (ATMs) typically sort notes by denomination during deposits. These devices often include multiple bins to accommodate different types of notes.

### SUMMARY

In various examples, methods and systems for classifying a note according to a version of the note are presented.

According to an example, a technique may include receiving, at a note handling device, a note, capturing identifying information about the note, and determining, using the identifying information, an identifier corresponding to the note, the identifier including a type, a value, an issuer, and a version of the note. The example technique may include classifying the note according to a rule associated with the identifier, the rule indicating a classification for the note and automatically sorting the note, at the note handling device, into a particular bin of the note handling device based on the classification.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various examples discussed in the present document.

FIG. 1 illustrates generally a schematic diagram of an ATM including internal components in accordance with some examples.

FIG. 2 illustrates generally a note, including identified features in accordance with some examples.

FIG. 3 illustrates generally a block diagram showing sorting rules in accordance with some examples.

FIG. 4 illustrates generally a flowchart showing a technique for classifying a note according to note version in accordance with some examples.

FIG. 5 illustrates generally an example of a block diagram of a machine upon which any one or more of the techniques discussed herein may perform in accordance with some examples.

### DETAILED DESCRIPTION

The systems and techniques described herein provide sorting of notes or other media according to one or more characteristics of the notes or other media. The characteristics may include an aspect of a note version, such as issuer (e.g., issuing central bank or country), serial number, year, style, security measure, or the like. The notes may be sorted automatically, such as at an ATM, for example when deposited in the ATM. Sorting the notes by characteristic may be done independently of sorting by denomination or verification of the note. In other examples, sorting by characteristic may use aspects of sorting by denomination or verification (e.g., a common image captured by a camera).

A recycler is a part of a machine (e.g., an ATM, a teller recycler, etc.) used to perform media handling, such as transactions with cash, for example to accept a deposit or dispense a withdrawal of the media. In an example, the recycler accepts a note and adds the note to an existing stock of notes by storing the note, for example in a cassette within the recycler. When a withdrawal is requested, the recycler dispenses a note from the stock (e.g., from a cassette). The note may be dispensed or received by a media conveyor via a slot (also called a media interface aperture) of a note transaction component. The note transaction component may include a media interface aperture cover that covers the media interface aperture. The media interface aperture cover is normally closed and opens to dispense or receive a note when a customer requests, is authorized, or is validated to receive or deposit the note. The note transaction component may include a user interface component, such as a display screen, encrypted touch screen, Personal Identification Number (PIN) pad, etc.

Genuine notes are typically sorted to a note bin on note deposit by denomination, for example currency or value. The systems and techniques described herein may provide a finer-grained sorting by note version. Sorting by note version may be helpful to remove older notes out of circulation, to separate notes from different issuing banks (e.g., to prioritize notes from a particular issuing bank remaining in circulation), to remove notes that have an error or security issue, or the like.

A note version may be identified in a file system field (e.g., a usRelease field in XFS). While that field may be used, there is currently no standardization of this field, which means that different hardware vendors report different values for the same note, as may different devices from a single vendor. The systems and techniques described herein provide for each version of each note to have a consistent definition, for example including mappings of how a version is reported by a particular device. The systems and techniques described herein may use the consistent definitions when defining how a note is to be handled or reported, rather than trying to rely on a device specific version. In examples where a bank requires different versions of a same denomination to be handled differently, the systems and techniques described herein may provide groups of note definitions to be used (e.g., all notes older than a particular year are to be removed from circulation, regardless of denomination).

The systems and techniques described herein provide a note definition, for example according to various criteria. The note definition may include an identification of a currency (e.g., in ISO 4217 format, such as GBP, USD, etc.), an absolute value (e.g., $10, £5, etc.), an issuing agency, (e.g., a central bank, such as the Bank of England, the U.S. Federal Reserve, etc.), a note version (e.g., including any format, typically a letter or number as defined by a bank, such as an issuing bank), or a version value (e.g., usRelease in XFS, such as a number between 0 and 65535). The issuing agency may be omitted if there are not multiple issuing agencies for the particular note. In an example, the usRelease number may include “NCR GBRU”=123 or “Diebold Recycler”=55.

The set of identifiers for a note may be standardized based on a convention such as, <Currency> <Value> <Agency> <Note Version>. An example standardized set of identifiers may include “GBP5BoE1” for version 1 of the Bank of England £5 note, where the currency is GBP, the value is 5, the issuing bank is BoE, and the note version is 1. The note definition may be supplied by the hardware vendor or defined before installation, such as by a system integrator.

An example Note Definition defined in JSON is shown in Table 1 below. This example includes two versions of £5 and £10 notes from both the Bank of England and the Royal Bank of Scotland, as well as how they may be reported in four different devices. In the example in Table 1, the first version of the £5 note has the same note version across four different devices, all being 1, while the second version of the £5 note has four different note versions for each corresponding device (i.e., 2, 12, 5, and 10). By mapping the second note versions at the device level to all be “version” “2”, a standardized version number may be used to sort the notes.

TABLE 1

```
  “currencies”: [
    {
      “currency”: “GBP”,
      “agencies”: [
        {
          “agency”: “Bank of England”,
          “values”: [
            {
              “value”: 5,
              “versions”: [
                {
                  “id”: “GBP5BoE1”,
                  “version”: “1”,
                  “releases”: {
                    “NCR SR”: 1,
                    “NCR BRM”: 1,
                    “NCR GBRU”: 1,
                    “DN Recycler”: 1
                  }
                },
                {
                  “id”: “GBP5BoE2”,
                  “version”: “2”,
                  “releases”: {
                    “NCR SR”: 2,
                    “NCR BRM”: 12,
                    “NCR GBRU”: 5,
                    “DN Recycler”: 10
                  }
                }
              ]
            },
            {
              “value”: 10,
              “versions”: [
                {
                  “id”: “GBP10BoE1”,
                  “version”: “1”,
                  “releases”: {
                    “NCR SR”: 2,
                    “NCR BRM”: 13,
                    “NCR GBRU”: 15,
                    “DN Recycler”: 110
                  }
                },
                {
                  “id”: “GBP10BoE2”,
                  “version”: “2”,
                  “releases”: {
                    “NCR SR”: 15,
                    “NCR BRM”: 122,
                    “NCR GBRU”: 52,
                    “DN Recycler”: 102
                  }
                }
              ]
            }
          ]
        },
        {
          “agency”: “Royal Bank of Scotland”,
          “values”: [
            {
              “value”: 5,
              “versions”: [
                {
                  “id”: “GBP5RBS1”,
                  “version”: “1”,
                  “releases”: {
                    “NCR SR”: 101,
                    “NCR BRM”: 101,
                    “NCR GBRU”: 111,
                    “DN Recycler”: 151
                  }
                },
                {
                  “id”: “GBP5RBS2”,
                  “version”: “2”,
                  “releases”: {
                    “NCR SR”: 102,
                    “NCR BRM”: 102,
                    “NCR GBRU”: 555,
                    “DN Recycler”: 1003
                  }
                }
              ]
            },
            {
              “value”: 10,
              “versions”: [
                {
                  “id”: “GBP10RBS1”,
                  “version”: “1”,
                  “releases”: {
                    “NCR SR”: 222,
                    “NCR BRM”: 123,
                    “NCR GBRU”: 156,
                    “DN Recycler”: 210
                  }
                },
                {
                  “id”: “GBP10RBS2”,
                  “version”: “2”,
                  “releases”: {
                    “NCR SR”: 115,
                    “NCR BRM”: 128,
                    “NCR GBRU”: 525,
                    “DN Recycler”: 1029
                  }
                }
              ]
            }
          ]
        }
      ]
    }
  ]
}
```

Note grouping may be used to treat a set of different notes (e.g., different versions, different denominations, etc.) as a group. The versions may be grouped according to bank requirements, for example. For example, a bank may not want to accept a particular note, such as the 500€ Euro note, because it may be associated with crime. A group may be created that includes an array of one or more note definition identifiers. For example when three versions of a Bank of England £5 note are to be handled in the same way then the group may include: “GBP5BoE″=” GBP5BoE1″, “GBP5BoE2”, “GBP5BoE3”. In another example, when a first definition is to be handled separately, for example to take it out of circulation, then the first definition may be included in a wider ‘catch-all’ group (e.g., which may be assigned to a mixed deposit cash unit for removal or further sorting): “All”=“GBP5BoE1”, “GBP5BoS1”, “GBP5RBS1”.

Notes may be defined in more than one group to allow overflow once a particular group is no longer available, for example when an assigned cash unit is full, inoperative, or removed. For example, a Bank of England £5 note, version 2 may be assigned first to a recirculate group, and then if the unit is full for that group, then to a catch-all group. In an example, each version may be assigned a default group in case no other group is assigned to a particular version: “All”=“GBP5BoE1l”, “GBP5BoE2”, “GBP5BoE3”, “GBP5BoS1”, “GBP5RBS1”.

Each note definition that a bank wants to accept may be assigned to one or more groups. Any note that the bank does not want to accept may be omitted from all groups (e.g., not assigned to any group). When a host requires a specific identifier for note groupings, the assigned group may be used as a group name or specified with an additional identifier.

An example grouping definition defined in JSON is provided below in Table 2. Table 2 includes note definitions from the example above and indicates groups based on a bank requirement to separate Bank of England notes from other GBP notes, but to use the common cash unit when the separate unit is unavailable.

The groups may then be used to apply a sorting rule at a recycler or ATM, for example to sort GBP5BoE group notes into a unit for removal from circulation, unless that unit is full, and when that unit is full, sort the GBP5BOE notes into a unit that actively redistributes the notes, along with the other notes (e.g., Royal Bank of Scotland issued notes). While the examples in Table 2 are shown as grouped according to issuer, any characteristic of a note may be used, such as age, type, etc.

TABLE 2

```
{
  “groups”: [
    {
      “GBP5BoE”: [
        “GBP5BoE1”,
        “GBP5BoE2”
      ]
    },
    {
      “GBP10BoE”: [
        “GBP10BoE1”,
        “GBP10BoE2”
      ]
    },
    {
      “All”: [
        “GBP5BoE1”,
        “GBP5BoE2”,
        “GBP10BoE1”,
        “GBP10BoE2”,
        “GBP5RBS1”,
        “GBP5RBS2”,
        “GBP1ORBS1”,
        “GBP10RBS2”
      ]
    }
  ]
}
```

Application handling may be used to sort notes based on version groups. An application may be used to configure a device or a cash unit. The application may use information corresponding to a device identifier, such as “NCR GBRU” or “Diebold Recycler” in the above examples. In an example, supported note types may be supplied in a WFS_INF_CIM_BANKNOTE_TYPES XFS command by a XFS service provider. Cash unit capabilities and configuration may be provided in WFS_INF_CIM_CASH_UNIT_INFO and WFS_INF_CIM_CASH_UNIT_CAPABILITIES XFS commands, respectively.

The application may map the information from WFS_INF_CIM_BANKNOTE_TYPES to the note definitions. In an example, the application may map the note definitions to the note groupings. Any note definition supported by the device but not assigned to a note groupings may be handled via a default procedure (e.g., ignored, sorted into a particular cash unit, etc.). The remaining note definitions may be configured for acceptance using the XFS command WFS_CMD_CIM_CONFIGURE_NOTETYPES. Any other notes may be refused during cash acceptance in WFS_CMD_CIM_CASH_IN. Each note grouping may be assigned to an appropriate cash unit using WFS_CMD_CIM_END_EXCHANGE according to the capabilities of the cash units.

In some examples, the systems and techniques described herein may be used with an application that captures note information from various devices in a network (e.g., of a financial institution, of a hardware manufacturer, etc.). The application may combine the note information, which may be used to determine rules for handling notes across the network. In these examples, the rules may be deployed to each ATM in the network. At each ATM, a standalone application may configure the ATM using XFS commands, according to the rules. Being standalone makes the solution quick or easy to deploy, and in some examples no existing ATM applications or platform software need to change to implement the systems and techniques. As rules change, or counterfeit threats are identified, the rules may be updated (e.g., based on new note information captured from one or more devices).

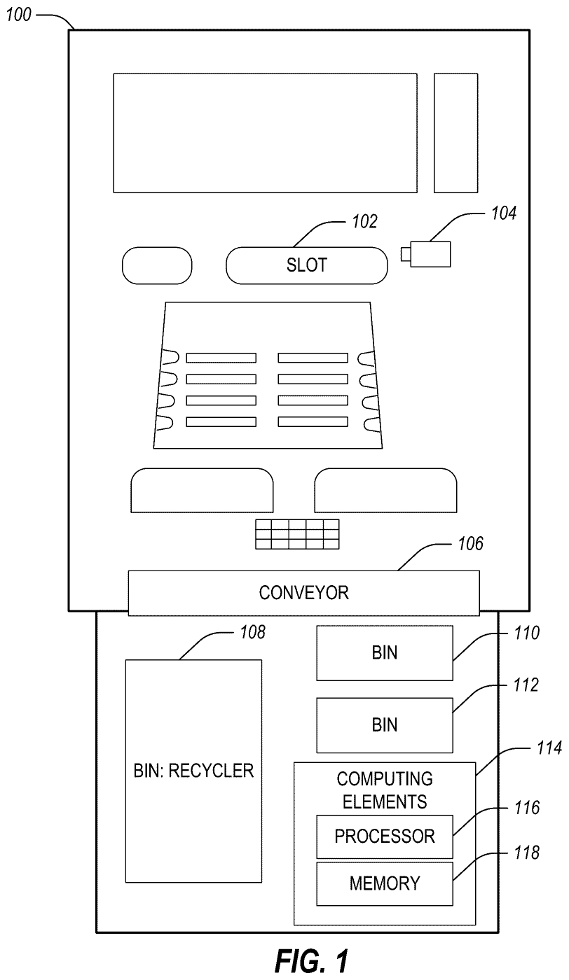

FIG. 1 illustrates generally a schematic diagram of an ATM 100 including internal components in accordance with some examples. The ATM 100 includes a slot 102 to receive or distribute notes. While the ATM 100 is shown from the outside, the remaining components of the ATM 100 are internal to the enclosure of the ATM 100, but are shown as visible for convenience. The ATM 100 includes a camera 104 for capturing an image of a note, for example when inserted through the slot 102. The image captured by the camera 104 may be used for determining a denomination of an input note, a validity of the input note (e.g., real or counterfeit), a version of the note, or the like. The ATM 100 includes a conveyor 106 to move the note to a particular bin, such as bin 108, bin 110, or bin 112. In an example, bin 108 is a recycler, which may distribute (e.g., via the conveyor 106 and the slot 102) a note to a customer of the ATM 100. The ATM 100 may include computing elements 114, such as a processor 116 or memory 118 to execute an application for sorting notes, such as according to a version of a note. The memory 118 may store groupings of note versions, store the application, or the like. The computing elements 114 may include firmware, such as a template for validating currency.

In some examples, the ATM 100 may accept multiple currencies. In these examples, the note definition may be used to identify a currency. A grouping may include only notes from a particular currency or a grouping may include notes from two or more currencies. For example, a first note definition may include Bank of England £5 notes of a first version as “GBP5BoE1”, a second version as “GBP5BoE2”, and a U.S. $10 note first version as “USD10FR1” (e.g., with the issuer being the Federal Reserve) and a second version as “USD10FR2.” The definitions may be sorted into groups such as a UK currency group, “GBP5BoE,” having “GBP5BoE1” and “GBP5BoE2” as members, a remove from circulation group, “RM,” having “GBP5BoE2” and “USD10FR2” as members, or the like. In some examples, such as for group “RM,” while both note versions in the group are to be removed, they may be separately sorted (e.g., into two different note units) because they are different currencies. In other examples, they may be sorted into the same unit for removal, even though they are different currencies.

The ATM 100 may include a bill validator, such as using the camera 104, a sensor, or the like to recognize a note. Firmware stored in the computing elements 114 may be used to determine which note was inserted into the slot 102, such as using template information. The template information may be part of a template that is used to define what notes are supported by the ATM 100, including optionally more than one currency. The template may have a certification cycle, taking time to develop, update, and certify (e.g., by a central bank). The template may not be able to sort by version. The bill validator may be used to validate a note during a dispense operation to ensure that the note matches the request. Typically problems may occur where the note unit has been incorrectly filled (e.g., where a cash unit that should contain $10 bills is filled with $20 bills). This same mechanism may be used to define what the cash unit should contain. When an error is identified, a recovery action may be taken, ensuring the correct amount is dispensed to the customer.

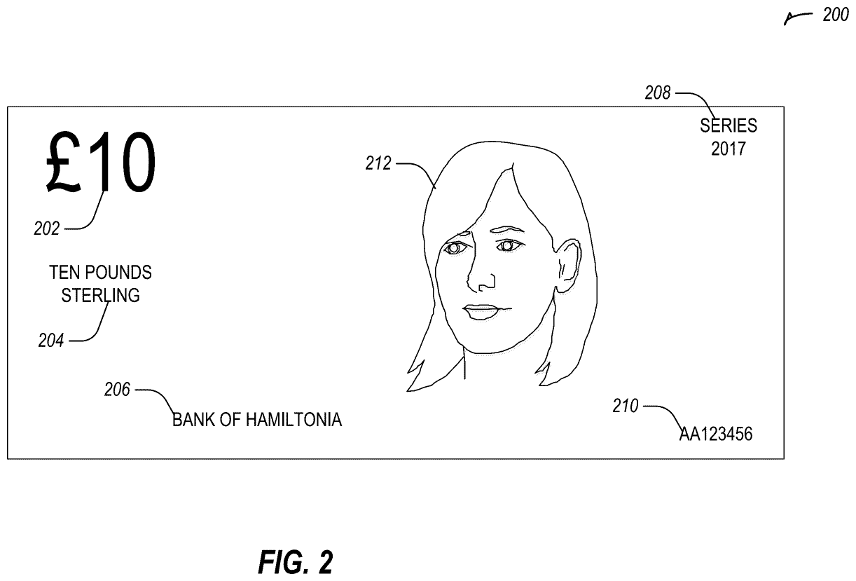

FIG. 2 illustrates generally a note 200, including identified features in accordance with some examples. The note 200 is presented in simplified form (e.g., leaving out security features and most adornments) for ease of discussion. The note 200 illustrates a £10 note that is identified by number value 202 and text 204. These features 202 or 204 may be used to determine a value of the note 200, to validate the note 200, to sort the note 200 according to value, etc.

The note 200 includes an issuer 206, in this case the fictional Bank of Hamiltonia. The issuer 206 may be used to group the note 200, sort the note 200, etc. The note 200 illustrates a date series 208, in this case an issued or originally issued year of 2017. As notes age, they may become difficult to handle or identify due to wear, and newer security measures may exist for more recently notes, making the aged notes less secure relatively. Aged notes may be removed from circulation for one or more of these reasons. The note 200 includes a serial number 210, in this case AA123456. The serial number 210 may be used to sort the note 200, for example according to a letter or number in the serial number 210. For example, a security flaw may be identified for all issued notes that start with AA, such as note 200. The note 200 may be grouped into a remove from circulation group based on the serial number 210. The note 200 includes a design feature 212 that may be used to identify or verify the note 200. In some examples, a counterfeit note may be identified. Counterfeit notes often have a limited range of serial numbers as they are copied. A financial institution may react to a counterfeit attack by defining a number range to identify to build a list of rejected serial numbers.

In an example, the note 200 may be defined as “GBP10BoH1,” since it is a £10 note issued by the Bank of Hamiltonia, and may be identified as version 1. A newer issued note (e.g., from 2018 or later) may include a modification to the design feature 212 or move a feature of the note 200, and that newer note may be identified as version 2 (e.g., “GBP10BoH2”). Both “GBP10BoH1” and “GBP10BoH2” may be sorted into an actively recycle group for £10 notes, such as group “GBP10BoH.” In another example, “GBP10BoH1” may be sorted into a remove from active recycle group (e.g., “RM”) due to its age from the date series 208, security (e.g., based on design feature 212), issuer 206, serial number 210, or the like.

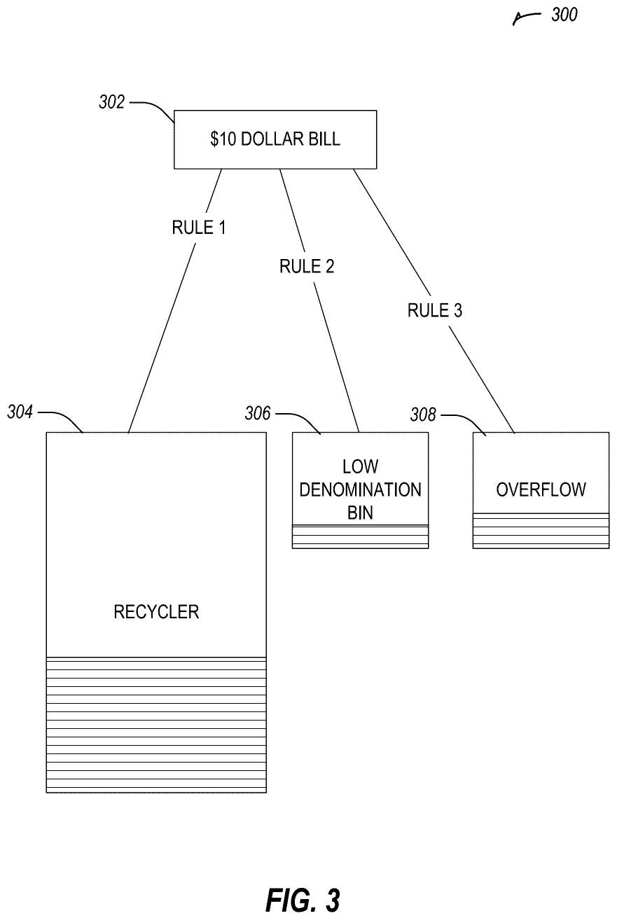

FIG. 3 illustrates generally a block diagram 300 showing sorting rules in accordance with some examples. The block diagram 300 illustrates sorting rules for a $10 bill 302. The $10 bill 302 may be sorted according to one or more groups that the $10 bill 302 is part of. The $10 bill 302 in block diagram 300 is illustrated with three rules, which are applied according to an order (e.g., rule 1, then if rule 1 cannot be satisfied, rule 2, then if rule 2 cannot be satisfied, rule 3).

In an example, rule 1 is the first rule in the ranking, and requires that the $10 bill 302 be placed in the recycler 304 when the recycler is not full. The recycler 304 may include different units for different denominations, in some examples. In the example shown in FIG. 3, the recycler 304 is not even half full, so the $10 bill 302 will be placed in the recycler 304 according to rule 1. However, when the recycler 304 is full, rule 1 cannot be satisfied, and instead rule 2 will be applied. Rule 2 indicates that the $10 bill 302 is to be placed in a low denomination bin 306 (e.g., for bills $20 and below). The low denomination bin 306 is not full, so the $10 bill 302 will be placed in that bin according to rule 2 when the recycler 304 is full. When both the recycler 304 and the low denomination bin 306 are full, then rule 3 is applied, which indicates that the $10 bill 302 will be placed in the overflow bin 308. In an example, such as when the recycler 304, the low denomination bin 306, and the overflow bin 308 are full, the $10 bill 302 may be rejected (e.g., not accepted because the device including the recycler 304, the low denomination bin 306, and the overflow bin 308 are all full).

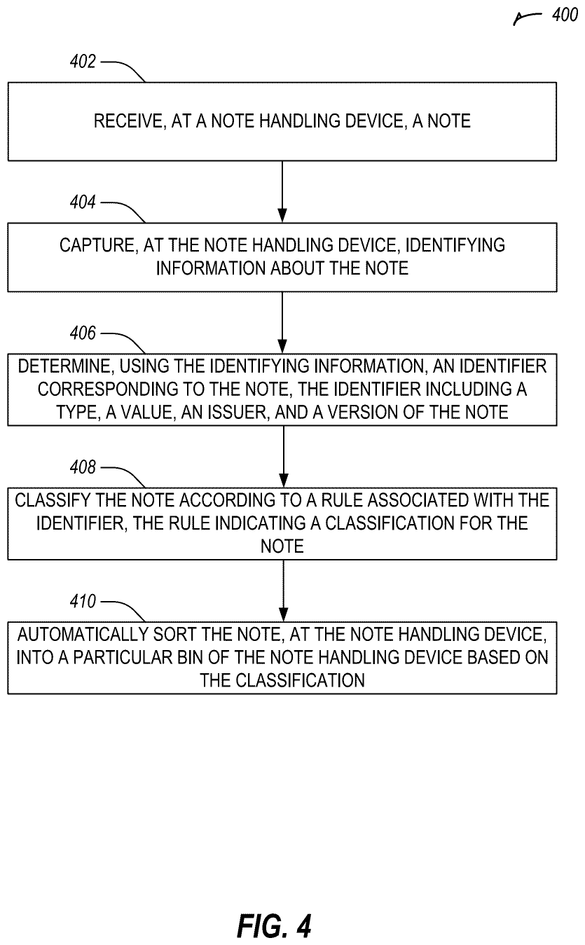

FIG. 4 illustrates generally a flowchart showing a technique 400 for classifying a note according to note version in accordance with some examples.

The technique 400 includes an operation 402 to receive, at a note handling device, a note. The note handling device may be an ATM, a teller cash recycler (TCR), a self-service terminal (SST), an interactive teller machine (ITM), a recycler, or the like. The note may be a bank note or other media.

The technique 400 includes an operation 404 to capture, at the note handling device, identifying information about the note.

The technique 400 includes an operation 406 to determine, using the identifying information, an identifier corresponding to the note, the identifier including a type, a value, an issuer, and a version of the note. The type may include a currency type. The value may include a monetary value of the note. The issuer may include a particular central bank.

The technique 400 includes an operation 408 to classify the note according to a rule associated with the identifier, the rule indicating a classification for the note. The rule may include a rule based on an age of the note associated with the identifier. In an example, rule is specified by a bank or entity operating the note handling device. The classification may include a set of notes, including the note, having a same type, a same value, or a same issuer. In an example, the rule classifies identifiers based on one of a same type, a same value, or a same issuer. The classification may include a set of notes, including the note, indicated to be taken out of circulation.

The technique 400 includes an operation 410 to automatically sort the note, at the note handling device, into a particular bin of the note handling device based on the classification. Operation 408 may include classifying the note into two or more classifications, the two or more classifications ranked according to bin priority. In this example, operation 410 may include automatically sorting the note based on the two or more classifications and a current bin status of a highest ranked bin in the bin priority. The technique 400 may include, before determining the identifier corresponding to the note, comparing the identifying information of the note to a template of the note handling device to validate the note.

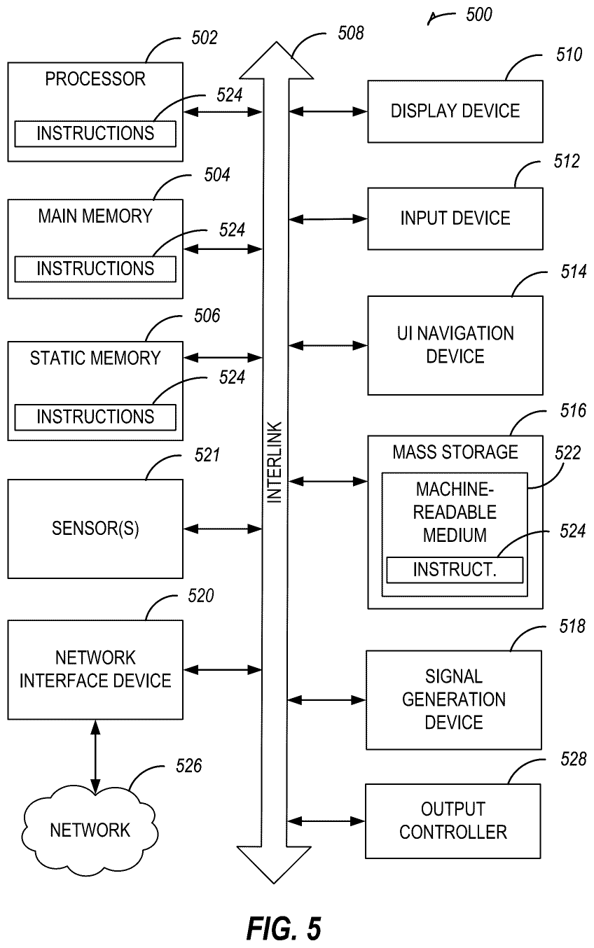

FIG. 5 illustrates generally an example of a block diagram of a machine 500 upon which any one or more of the techniques discussed herein may perform in accordance with some examples. In alternative examples, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring may occur under the direction of the executions units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module.

Machine (e.g., computer system) 500 may include a hardware processor 502 (e.g., a central processing unit (CPU), a graphics processing unit (GPU), a hardware processor core, or any combination thereof), a main memory 504 and a static memory 506, some or all of which may communicate with each other via an interlink (e.g., bus) 508. The machine 500 may further include a display unit 510, an alphanumeric input device 512 (e.g., a keyboard), and a user interface (UI) navigation device 514 (e.g., a mouse). In an example, the display unit 510, alphanumeric input device 512 and UI navigation device 514 may be a touch screen display. The machine 500 may additionally include a storage device (e.g., drive unit) 516, a signal generation device 518 (e.g., a speaker), a network interface device 520, and one or more sensors 521, such as a global positioning system (GPS) sensor, compass, accelerometer, or other sensor. The machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 516 may include a machine readable medium 522 that is non-transitory on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the machine 500. In an example, one or any combination of the hardware processor 502, the main memory 504, the static memory 506, or the storage device 516 may constitute machine readable media.

While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 524 may further be transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), or wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 500, and includes digital or analog communications signals or other intangible medium to facilitate communication of such software.

Each of these non-limiting examples may stand on its own, or may be combined in various permutations or combinations with one or more of the other examples.

Example 1 is a method comprising: receiving, at a note handling device, a note; capturing, at the note handling device, identifying information about the note; determining, using the identifying information, an identifier corresponding to the note, the identifier including a type, a value, an issuer, and a version of the note; classifying the note according to a rule associated with the identifier, the rule indicating a classification for the note; and automatically sorting the note, at the note handling device, into a particular bin of the note handling device based on the classification.

In Example 2, the subject matter of Example 1 includes, wherein the note handling device is an automated teller machine (ATM).

In Example 3, the subject matter of Examples 1-2 includes, wherein the note is a bank note.

In Example 4, the subject matter of Examples 1-3 includes, wherein the rule is based on an age of the note associated with the identifier.

In Example 5, the subject matter of Examples 1˜4 includes, wherein the type is a currency type, the value is a monetary value of the note, and the issuer is a central bank.

In Example 6, the subject matter of Examples 1-5 includes, wherein the rule is specified by a bank or entity operating the note handling device.

In Example 7, the subject matter of Examples 1-6 includes, wherein the classification includes a set of notes, including the note, having a same type, a same value, or a same issuer, and wherein the rule classifies identifiers based on one of the same type, the same value, or the same issuer.

In Example 8, the subject matter of Examples 1-7 includes, wherein the classification includes a set of notes, including the note, indicated to be taken out of circulation.

In Example 9, the subject matter of Examples 1-8 includes, wherein classifying the note includes classifying the note into two or more classifications, the two or more classifications ranked according to bin priority, and wherein automatically sorting the note includes automatically sorting the note based on the two or more classifications and a current bin status of a highest ranked bin in the bin priority.

In Example 10, the subject matter of Examples 1-9 includes, before determining the identifier corresponding to the note, comparing the identifying information of the note to a template of the note handling device to validate the note.

Example 11 is a note handling device comprising: a plurality of bins including a bin; a slot configured to receive a note; at least one conveyor configured to move notes from the slot to the bin of the plurality of bins; a camera configured to capture identifying information about the note; processing circuitry; and memory, including instructions, which when executed by the processing circuitry, cause the processing circuitry to perform operations to: determine, using the identifying information, an identifier corresponding to the note, the identifier including a type, a value, an issuer, and a version of the note; classify the note according to a rule associated with the identifier, the rule indicating a classification for the note; and automatically output control instructions to cause the at least one conveyor to convey the note into the bin based on the classification.

In Example 12, the subject matter of Example 11 includes, wherein the bin is a recycler configured to receive and output notes.

In Example 13, the subject matter of Examples 11-12 includes, wherein the at least one conveyor is configured to move notes from the slot to any bin of the plurality of bins.

In Example 14, the subject matter of Examples 11-13 includes, wherein the instructions, when executed, further cause the processing circuitry to validate the note based on the identifying information by comparing the identifying information to a template stored in the memory.

In Example 15, the subject matter of Examples 11-14 includes, wherein the note handling device is an automated teller machine (ATM).

In Example 16, the subject matter of Examples 11-15 includes, wherein the note is a bank note.

In Example 17, the subject matter of Examples 11-16 includes, wherein the rule is based on an age of the note associated with the identifier.

In Example 18, the subject matter of Examples 11-17 includes, wherein the type is a currency type, the value is a monetary value of the note, and the issuer is a central bank.

In Example 19, the subject matter of Examples 11-18 includes, wherein the classification includes a set of notes, including the note, having a same type, a same value, or a same issuer, and wherein the rule classifies identifiers based on one of the same type, the same value, or the same issuer.

In Example 20, the subject matter of Examples 11-19 includes, wherein the classification includes a set of notes, including the note, indicated to be taken out of circulation.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

1. A method comprising:
receiving, at a note handling device, a note;
capturing, at the note handling device, identifying information about the note;
determining, using the identifying information, an identifier corresponding to the note, the identifier including a type, a value, an issuer, and a version of the note;
classifying the note according to a rule associated with the identifier, the rule indicating a classification for the note based on the issuer matching one of a plurality of issuers; and
automatically sorting the note, at the note handling device, into a particular bin among a plurality of bins of the note handling device based on the classification, the particular bin corresponding to the issuer.

2. The method of claim 1, wherein the note handling device is an automated teller machine (ATM).

3. The method of claim 1, wherein the note is a bank note.

4. The method of claim 1, wherein the rule is based on an age of the note associated with the identifier.

5. The method of claim 1, wherein the type is a currency type, the value is a monetary value of the note, and the issuer is a central bank.

6. The method of claim 1, wherein the rule is specified by a bank or entity operating the note handling device.

7. The method of claim 1, wherein the classification includes a set of notes, including the note, having a same type, a same value, or a same issuer, and wherein the rule classifies identifiers based on one of the same type, the same value, or the same issuer.

8. The method of claim 1, wherein the classification includes a set of notes, including the note, indicated to be taken out of circulation.

9. The method of claim 1, wherein classifying the note includes classifying the note into two or more classifications, the two or more classifications ranked according to bin priority, and wherein automatically sorting the note includes automatically sorting the note based on the two or more classifications and a current bin status of a highest ranked bin in the bin priority.

10. The method of claim 1, further comprising, before determining the identifier corresponding to the note, comparing the identifying information of the note to a template of the note handling device to validate the note.

11. A note handling device comprising:
a plurality of bins including a bin corresponding to an issuer;
a slot configured to receive a note;
at least one conveyor configured to move notes from the slot to the bin of the plurality of bins;
a camera configured to capture identifying information about the note;
processing circuitry; and
memory, including instructions, which when executed by the processing circuitry, cause the processing circuitry to perform operations to:
determine, using the identifying information, an identifier corresponding to the note, the identifier including a type, a value, the issuer, and a version of the note;
classify the note according to a rule associated with the identifier, the rule indicating a classification for the note based on the issuer matching one of a plurality of issuers; and
automatically output control instructions to cause the at least one conveyor to convey the note into the bin corresponding to the issuer based on the classification.

12. The note handling device of claim 11, wherein the bin is a recycler configured to receive and output notes.

13. The note handling device of claim 11, wherein the at least one conveyor is configured to move notes from the slot to any bin of the plurality of bins.

14. The note handling device of claim 11, wherein the instructions, when executed, further cause the processing circuitry to validate the note based on the identifying information by comparing the identifying information to a template stored in the memory.

15. The note handling device of claim 11, wherein the note handling device is an automated teller machine (ATM).

16. The note handling device of claim 11, wherein the note is a bank note.

17. The note handling device of claim 11, wherein the rule is based on an age of the note associated with the identifier.

18. The note handling device of claim 11, wherein the type is a currency type, the value is a monetary value of the note, and the issuer is a central bank.

19. The note handling device of claim 11, wherein the classification includes a set of notes, including the note, having a same type, a same value, or a same issuer, and wherein the rule classifies identifiers based on one of the same type, the same value, or the same issuer.

20. The note handling device of claim 11, wherein the classification includes a set of notes, including the note, indicated to be taken out of circulation.
